(19) United States
(12) Patent Application Publication
(10) Pub. No.: US 2025/0374116 A1
(43) Pub. Date: Dec. 4, 2025

(54) DELAY STATUS REPORT MEDIUM ACCESS CONTROL CONTROL ELEMENT FORMAT SELECTION

(71) Applicant: Apple Inc., Cupertino, CA (US)

(72) Inventors: Ping-Heng Kuo, London (GB); Ralf Rossbach, Munich (DE)

(73) Assignee: Apple Inc., Cupertino, CA (US)

(21) Appl. No.: 18/826,014

(22) Filed: Sep. 5, 2024

Related U.S. Application Data
(60) Provisional application No. 63/655,966, filed on Jun. 4, 2024.

(51) Int. Cl. H04W 28/02

(52) U.S. Cl. CPC H04W 28/0278

(57) ABSTRACT

The present application relates to devices and components including apparatus, systems, and methods to select a delay status report (DSR) medium access control (MAC) control element (CE) format for a DSR.

### CROSS-REFERENCE TO RELATED APPLICATIONS

This application claims priority to U.S. provisional application No. 63/655,966, entitled “Delay Status Report Medium Access Control Control Element Format Selection,” filed on Jun. 4, 2024, the disclosure of which is incorporated by reference herein in its entirety for all purposes.

### TECHNICAL FIELD

The present application relates to the field of wireless technologies and, in particular, to selection of delay status report (DSR) medium access control (MAC) control element (CE) formats for delay status reporting.

### BACKGROUND

Third Generation Partnership Project (3GPP) networks provide for transmissions between user equipments (UEs) and base stations to provide services for a user. To facilitate transmissions from the UEs to the base stations, the UEs have buffers that can store data (such as packets) to be transmitted to the base stations. However, the buffers are configured to store data for a limited amount of time due to the limited space of the buffers. The data is discarded at the expiration of the limited amount of time regardless of whether the data was transmitted to the target base station.

### BRIEF DESCRIPTION OF THE DRAWINGS

FIG. 1 illustrates a network environment in accordance with some embodiments.

FIG. 2 illustrates a user equipment in accordance with some embodiments.

FIG. 3 illustrates a network device in accordance with some embodiments.

FIG. 4 illustrates an example delay status report (DSR) timing representation 400 in accordance with some embodiments.

FIG. 5 illustrates an example DSR medium access control (MAC) control element (CE) structure in accordance with some embodiments.

FIG. 6 illustrates an example procedure for DSR MAC CE format selection in accordance with some embodiments.

FIG. 7 illustrates an example DSR MAC CE structure in accordance with some embodiments.

FIG. 8 illustrates another example DSR MAC CE structure in accordance with some embodiments.

FIG. 9 illustrates an example procedure for generating a DSR in accordance with some embodiments.

FIG. 10 illustrates an example procedure for generating a DSR in accordance with some embodiments.

FIG. 11 illustrates an example procedure for indicating a DSR MAC CE format to be utilized in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

The term “buffer delay report” and “delay status report” as used herein may refer to a same report. Accordingly, the term “buffer delay report” and “delay status report” may be used interchangeably herein to refer to a same report. Further, “buffer delay reporting” and “delay status reporting” may be used interchangeably as well.

Some approaches described throughout this disclosure may provide for selection of a delay status report (DSR) medium access control (MAC) control element (CE) formats for transmission of a DSR from a plurality of DSR MAC CE formats. Legacy approaches include a single DSR MAC CE format that provides limited information. It can be desirable for operation to provide additional information and/or fields within a DSR MAC CE, which can lead to two or more different DSR MAC CE formats be defined for operation. When multiple different DSR MAC CE formats, it can be beneficial to utilize different DSR MAC CE formats in different situations, such as when a channel quality is insufficient for one or more of the multiple different DSR MAC CE formats and/or the resources allocated for a DSR are insufficient for one or more of the multiple different DSR MAC CE formats. The approaches described herein can determine a DSR MAC CE format for a DSR based on characteristics related to the DSR. Additionally, approaches described throughout this disclosure may provide for DSRs including one or more indications of information included in the DSRs and/or buffer size information for the DSRs.

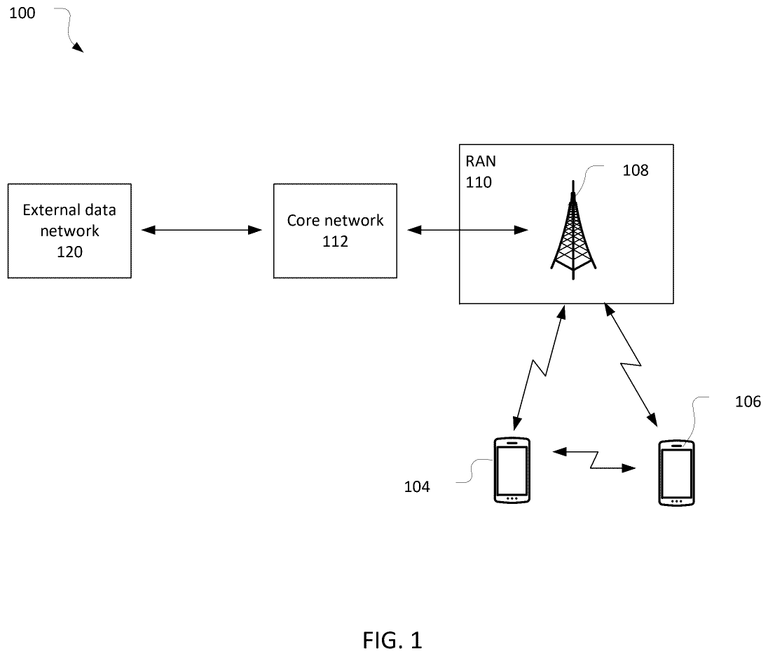

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

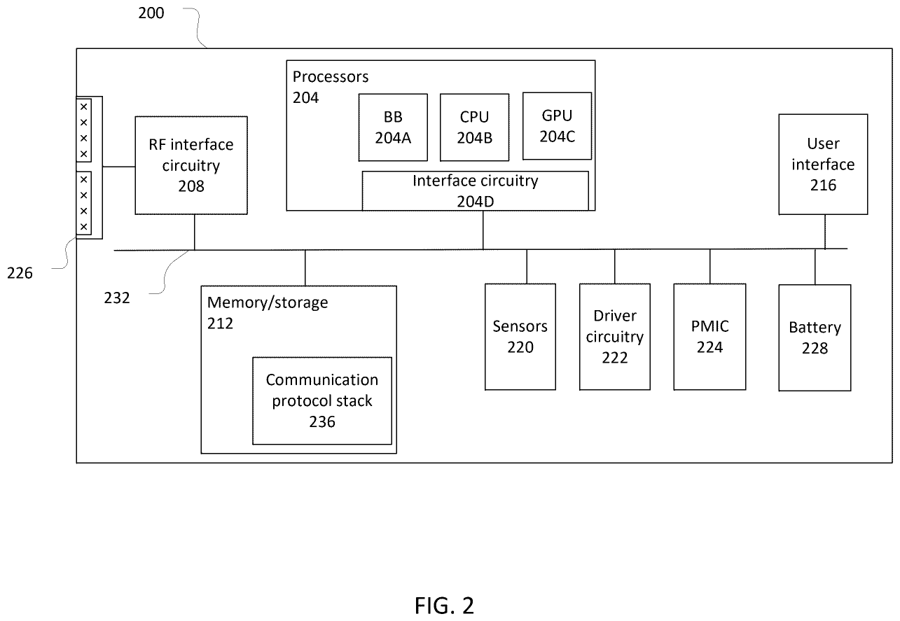

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals.

The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

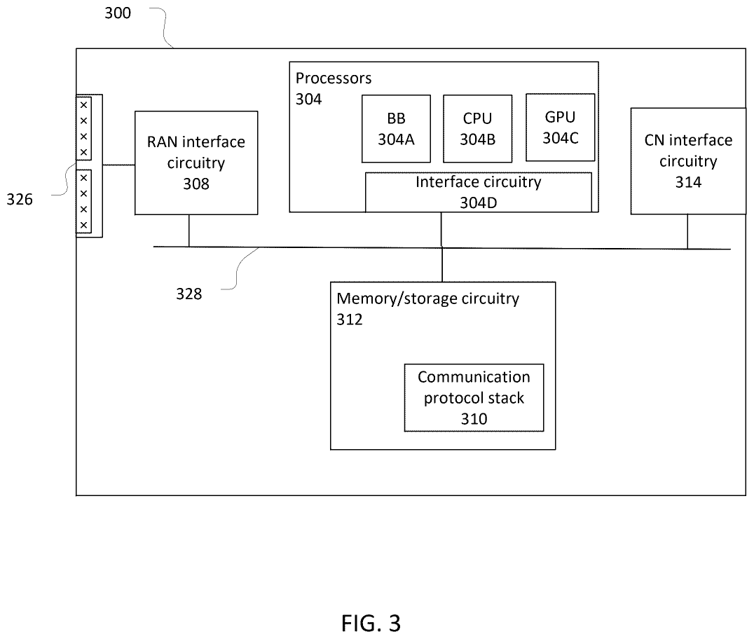

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

In order to assist delay-aware scheduling for extended reality (XR), mechanisms for delay status reporting have been specified in third generation partnership project (3GPP) release 18 (Rel-18). The delay status reporting medium access control (MAC) control element (CE) is triggered when the remaining time of data till the discard timer expiry in a logical channel (LCH) satisfies a remaining time threshold.

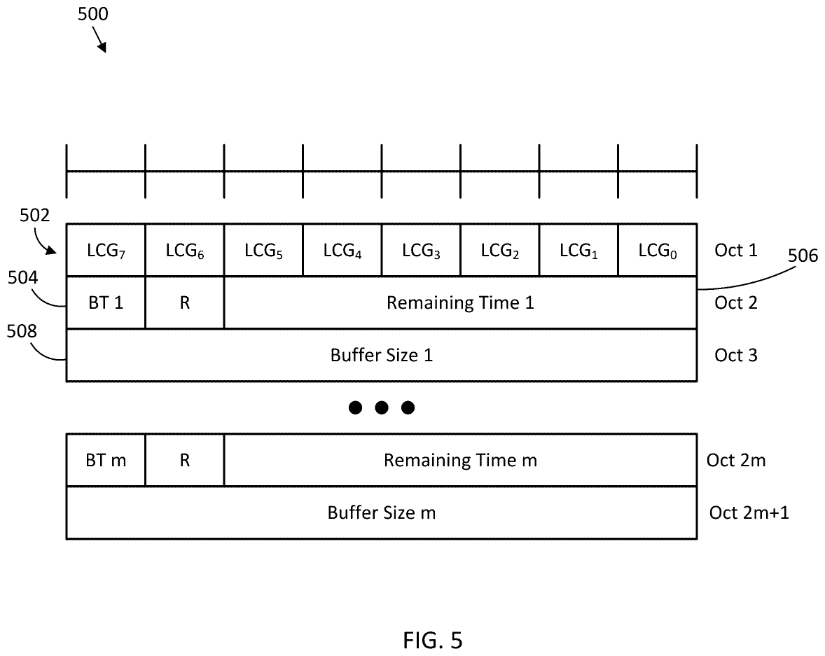

The report includes the information of the remaining time till the discard timer expiry (the reference point is the starting of the uplink shared channel (UL-SCH) for such MAC CE), as well as the data volume (i.e., buffer size) account for such remaining time. The delay status reporting MAC CE structure adopted in Rel-18 is shown below in FIG. 5.

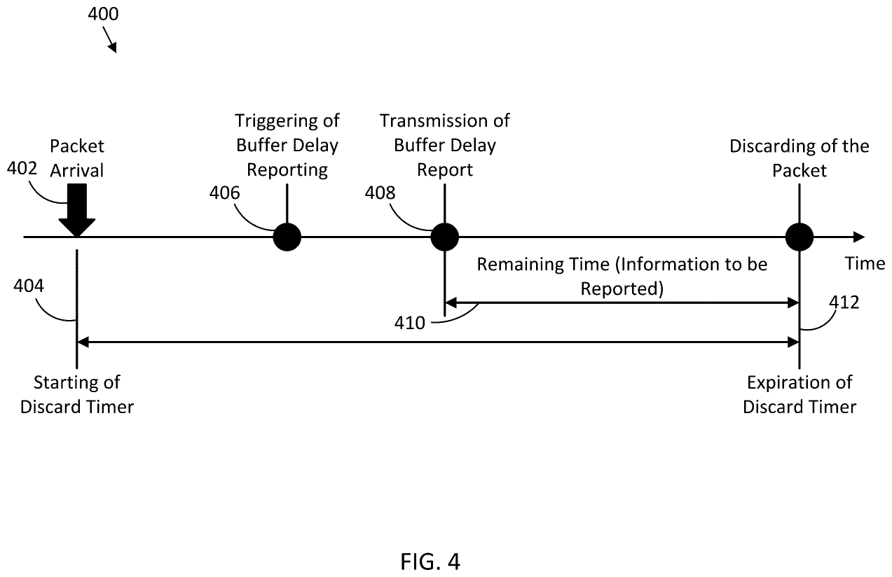

FIG. 4 illustrates an example delay status report (DSR) timing representation 400 in accordance with some embodiments. For example, the representation 400 illustrates an example of delay status reporting procedure in accordance with some embodiments. One or more of the operations illustrated in the representation 400 may be performed by a user equipment (UE), such as the UE 104 (FIG. 1), UE 106 (FIG. 1), and/or the UE 200 (FIG. 2).

The representation 400 includes a packet arrival 402. The UE may receive a packet from the upper layers at the packet arrival 402, where the packet is to be transmitted to a base station. In some embodiments, the packet may be received by the UE, or a portion thereof, from an application layer.

A discard timer may be started at 404 based on the packet arrival 402. For example, the UE may start a discard timer when the packet is received. The UE may be configured to discard the packet received at the packet arrival 402 at an expiry of the discard timer.

A buffer delay reporting may be triggered at 406. The buffer delay reporting may be triggered based on a remaining time of the discard timer dropping below a threshold time. For example, the UE may determine that the remaining time of the discard timer dropped below the threshold time. The UE may collect information to be included in the buffer delay report and/or may generate the buffer delay report in response to the buffer delay reporting being triggered in 406.

The UE may transmit the buffer delay report at 408. For example, the UE may transmit the buffer delay report to the base station at 408. The UE may transmit the buffer delay report at 408 due to a resource being available for transmission of the delay report at 408. The buffer delay report may include an indication of a remaining time 410 of the discard timer at the time of transmission of the buffer delay report. The buffer delay report may facilitate the network in scheduling the packet for transmission.

The discard timer may expire at 412. The UE may determine that the discard timer has expired and discard the packet at 414. The UE may discard the packet at 414 whether or not the packet has been transmitted to the base station.

FIG. 5 illustrates an example DSR MAC CE structure 500 in accordance with some embodiments. The structure 500 may have a Rel-18 DSR MAC CE format, where the structure 500 is an example of a structure that may be utilized in Rel-18. The MAC CE defined in Rel-18 may allow the UE to report the data volume associating with the smallest remaining time per logical channel group (LCG).

The structure 500 may include one or more LCG indication fields 502. The LCG indication fields 502 may indicate for which LCGs the structure 500 includes information. The LCG indication fields 502 may indicate the presence of delay information for the LCGs. An LCG indication field of the LCG indication fields 502 set to 1 may indicate that the delay information for the LCG is reported. An LCG field set to 0 may indicate that the delay information for the LCG is not reported.

The structure 500 may include sections for each of the LCGs indicated by the LCG indication fields 502. Each section may include a buffer size table indicator field, a remaining time indication field, and a buffer size indication field. For example, a first section corresponding to the LCG includes a first buffer size table indicator field 504, a first remaining time indication field 506, and a first buffer size indication field 508 in the illustrated embodiment. The buffer size table indicator field may indicate the total amount of delay-critical uplink (UL) data for an LCG and/or may indicate a defined table that indicates a buffer size corresponding to the LCG. The remaining time indication field may indicate an amount of time remaining on a discard timer corresponding to the LCG. The buffer size indication may indicate the shortest remaining value of running packet data convergence protocol (PDCP) discardTimer among all PDCP service data units (SDUs) that are buffered for an LCG but have not been transmitted in any MAC packet data unit (PDU), at the time of the first symbol of the first physical uplink shared channel (PUSCH) transmission that includes this DSR MAC CE.

For example, the fields in the DSR MAC CE, in the DSR MAC CE structure 500, may be defined as follows.

LCGᵢ: This field may indicate the presence of delay information (i.e., the Remaining Time and Buffer Size fields) for the LCGᵢ. The LCGᵢ field set to 1 may indicate that the delay information for the LCG i, is reported. The LCGᵢ field set to 0 may indicate that the delay information for the LCG i is not reported.

Remaining Time: This field may indicate the shortest remaining value of running packet data convergence protocol (PDCP) discardTimer among all PDCP service data units (SDUs) that are buffered for an LCG but have not been transmitted in any MAC packet data unit (PDU), at the time of the first symbol of the first physical uplink shared channel (PUSCH) transmission that includes this DSR MAC CE. The length of this field may be 6 bits. This field may be present only if the buffer size indicated by the corresponding Buffer Size field is not zero; otherwise, this field may be reserved and set to 0. If present, the value r in this field may indicate a remaining time within the range of (r, r+1] milliseconds (msec).

BT: This field may be present only if the corresponding LCG is configured with additionalBS-TableAllowed and the buffer size indicated by the corresponding Buffer Size field is not zero; otherwise, this field may be reserved and set to 0. If present, the BT field set to 1 may indicate that the buffer sizes specified in Table 6.1.3.1-3 of technical specification (TS) 38.323 (3^{rd} Generation Partnership Project; Technical Specification Group Radio Access Network; NR; Packet Data Convergence Protocol (PDCP) specification (Release 18). (2024). 3GPP TS 38.323, 18.1.0) are used to set the value of the Buffer Size field, while the BT field set to 0 may indicate that the buffer sizes specified in Table 6.1.3.1-2 of TS 38.323 are used instead.

Buffer Size: The Buffer Size field may indicate the total amount of delay-critical uplink (UL) data for an LCG according to the data volume calculation procedure specified in clause 5.5 in TS 38.322 (3rd Generation Partnership Project; Technical Specification Group Radio Access Network; NR; Radio Link Control (RLC protocol specification (Release 18). (2023). 3GPP TS 38.322, 18.0.0) and clause 5.15 in TS 38.323 for the associated radio link control (RLC) and PDCP entities, respectively, after the MAC PDU has been built. If the corresponding LCG is configured with additionalBS-TableAllowed and the amount of delay-critical UL data for an LCG is within the buffer sizes specified in Table 6.1.3.1-3, the MAC entity may use the buffer sizes specified in Table 6.1.3.1-3 to set the value of this field; otherwise, the MAC entity may use Table 6.1.3.1-2 instead. This field may be indicated in number of bytes. The length of this field may be 8 bits.

Potential delay status reporting enhancements may be introduced in release 19 (Rel-19). For example, enhancements to DSR for extended reality (XR) for Rel-19 may be desirable. In particular, additional information can be included in DSR MAC CE to provide a more comprehensive view to the base station (such as a next generation NodeB (gNB)) about the buffer status.

The following directions for enhancements for Rel-19 may be considered. Rel-19 DSR may be enhanced to include multiple (remaining time, buffer size) pairs per LCG. Rel-19 DSR may be enhanced to include multiple buffer size information per LCG that correspond to multiple remaining time threshold levels. Rel-19 DSR may additionally include data volume of non-delay-critical data (i.e., the data with remaining time larger than the threshold). Rel-19 DSR may include the importance level of the delay-critical data (e.g., whether the reported delay-critical data includes PDU Set that is considered important or less important). Rel-19 DSR may include information of remaining time and delay-critical data volume per logical channel (LCH) (rather than per LCG). Rel-19 DSR may include the total data volume and multiple remaining time values corresponding to different percentile portions of the total data volume. One or more of these directions for enhancements may be implemented in different embodiments.

Enhancing existing DSR with additional information may be considered, e.g., multiple pairs of remaining time/buffer information, importance. Whether this only includes more information on delay-critical data or also information about non-delay critical data may be for further study.

Assuming at least one additional DSR MAC CE format (or additional type of DSR MAC CE) is to be introduced on top of the legacy Rel-18 DSR, the methods/procedures for the UE to decide which DSR format (or type) it should select and report when DSR is triggered may be specified.

Some observations regarding DSR include the following. In legacy approaches, DSR enablement is configured per LCG, i.e., the UE only triggers DSR for the LCHs in the LCGs that are configured with such mechanism. The DSR for an LCH/LCG is triggered when the remaining time of one buffered PDCP SDU drops below a remaining time threshold. Furthermore, in one DSR MAC CE, the UE only reports the DSR information for the LCGs whose LCHs have triggered DSR (i.e., the LCGs with pending DSR). Since only one DSR MAC CE format is defined, the UE always reports delay information based on the same format in Rel-18. Rel-19 may introduce one or more new DSR formats that could convey more information, which potentially has higher signaling overhead. Therefore, new DSR format may be used for reporting only when it is needed.

An issue that may be presented by the introduction of one or more new DSR formats may be how does the UE select the DSR MAC CE format, when it intends to send DSR that has been triggered by at least one LCHs?

A first approach (which may be referred to as “Approach 1”) may include conditional DSR MAC CE format selection. Some assumptions for the first approach may include that there may be multiple DSR formats, including Rel-18 DSR MAC CE format and one or more Rel-19 DSR MAC CE format(s). Some DSR MAC CE formats may have fields such as LCH identifier (ID) or LCG ID, rather than based on the bitmap in Rel-18. The one or more Rel-19 DSR MAC CE formats may include more or different information and/or more or different fields as compared to the Rel-18 DSR MAC CE format.

When DSR is triggered, there are two possible cases. In a first case, the UE may always use a specific DSR MAC CE format (e.g., Rel-18 format or a Rel-19 format). Or in a second case, the UE may select a DSR format based on whether certain conditions are satisfied. The conditions can be fixed by specification, or pre-configured by the network (e.g., via radio resource control (RRC)). Approaches described herein may relate to the second case.

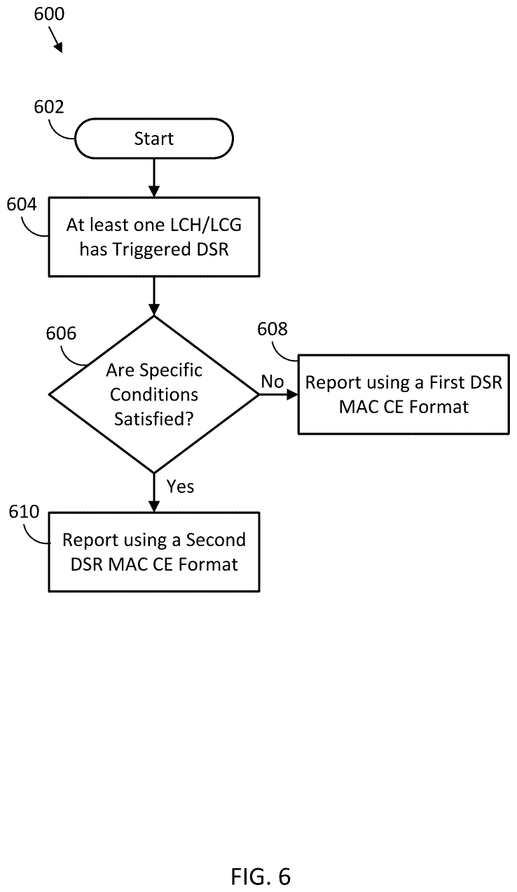

FIG. 6 illustrates an example procedure 600 for DSR MAC CE format selection in accordance with some embodiments. The procedure 600 may be performed by a UE to select a DSR MAC CE format for transmission of a DSR. The procedure 600 may be performed as part of the first approach.

The procedure 600 may start at 602. The procedure 600 may include at least one LCH or LCG having triggered delay status reporting in 604. For example, a remaining time for a discard timer of at least one LCH or LCG may be less than a threshold time. The triggering of the delay status reporting may include one or more of the features of the trigger of the buffer delay reporting in 406 (FIG. 4). The triggering of the delay status reporting may indicate that a DSR is to be generated and/or transmitted to a base station.

The procedure 600 may include determining whether specific conditions are satisfied in 606. For example, the UE may determine whether specific conditions related to the DSR are satisfied. In some embodiments, the UE may determine characteristics related to the DSR to determine whether the specific conditions related to the DSR are satisfied. In some embodiments, the conditions may be related to one or more buffered data volumes of the LCHs and/or LCGs that triggered the DSR, one or more remaining time values of buffered data of the LCHs and/or LCGs that triggered the DSR, one or more configurations of delay status reporting of the LCHs and/or the LCGs that triggered the DSR, a number of the LCHs and/or LCGs that triggered the DSR, one or more importance levels of buffered data of the LCHs and/or LCGs that triggered the DSR, a number of padding bits in a radio resource to be utilized for transmission of the DSR, a size of a radio resource to be utilized for transmission of the DSR, and/or a type of a radio resource to be utilized for transmission of the DSR. If the conditions are not satisfied, the procedure 600 may proceed to 608. If the conditions are satisfied, the procedure 600 may proceed to 610.

The procedure 600 may report the DSR using a first DSR MAC CE format in 608. In some embodiments, the first DSR MAC CE format may be the legacy Rel-18 DSR MAC CE format. The UE may generate a DSR in accordance with the first DSR MAC CE format and/or transmit the DSR to the base station.

The procedure 600 may report the DSR using a second DSR MAC CE format in 610. In some embodiments, the second DSR MAC CE format may be a Rel-19 DSR MAC CE format. The second DSR MAC CE format may include additional information and/or additional fields as compared to the first DSR MAC CE format. The UE may generate a DSR in accordance with the second DSR MAC CE format and/or transmit the DSR to the base station.

The conditions to determine a DSR MAC CE format to be utilized for a DSR can be based on at least one of the following. A first condition may be the number of LCGs/LCHs that have triggered DSR. As a first example of the first condition, the UE may use a first DSR MAC CE when there is only one LCG that has triggered DSR, and may use a second DSR MAC CE when there are multiple LCGs that have triggered DSR. As a second example of the first condition, the UE may use a first DSR MAC CE when there are fewer than N LCG that have triggered DSR, and may use a second DSR MAC CE when there are N or more LCGs that have triggered DSR, N being a configured number.

A second condition may include specific LCGs/LCHs have triggered DSR. As a first example of the second condition, one or more LCH/LCG may have been configured to enable a first DSR MAC CE format. When at least one (or more) of these LCHs/LCGs have triggered DSR, the UE may use the first DSR MAC CE format. Otherwise, if none of these LCHs/LCGs have triggered DSR, the UE may use a second DSR MAC CE format when the DSR is triggered by any other LCHs/LCGs.

As a second example of the second condition, when at least one (or more) LCHs/LCGs with priority higher/lower than a threshold have triggered DSR, the UE may use a first DSR MAC CE format. Otherwise, the UE may use a second DSR MAC CE format.

As a third example of the second condition, when at least one (or more) LCHs/LCGs have delay-critical (or non-delay-critical) data volume larger/smaller than a threshold (or within a range) have triggered DSR, the UE may use a first DSR MAC CE format. Otherwise, the UE may use a second DSR MAC CE format.

In some embodiments, DSR MAC CE format selection can be based on the distributions of (delay-critical) data volume across different remaining time ranges. Assuming multiple remaining threshold levels are defined, and each LCH/LCG may have different data volume associating to different “remaining time ranges” or “remaining time thresholds,” such as: data volume with remaining time less than 5 milliseconds (ms): 800 kilobytes (K); data volume with remaining time between 5 ms and 10 ms: 200 K; and data volume with remaining time between 10 ms and 20 ms: 500 K. For example, data volume for less than 5 ms may have a threshold of 800 K, data volume with remaining time between 5 ms and 10 ms may have a threshold of 200 K, and data volume with remaining time between 10 ms and 20 ms may have a threshold of 500 K in this embodiment.

The UE may select DSR format based on the amount of data in each remaining time range for one or more LCH/LCG. For example, if at least one LCH/LCG triggered DSR has data volume higher than a threshold (e.g., zero) in more than one predefined remaining time ranges, the DSR may be reported based on a first DSR MAC CE format. Otherwise, the DSR may be reported based on a second DSR MAC CE format. There could be many other examples of the UE selecting DSR format based on the amount of data in each remaining time range for one or more LCH/LCG. In one example, the UE may select the DSR format based on at least one difference of values among the multiple data volumes corresponding to multiple remaining time thresholds or remaining time ranges.

In some embodiments, the DSR MAC CE format selection can be based on the distributions of remaining time values of buffered data. For example, if the difference between the maximum and minimum remaining time exceeds a threshold, the UE may select the first DSR format. Otherwise, the UE may select the second DSR format. For another example, if all the buffered data have the same remaining time, the UE may select the first DSR format. Otherwise, the UE may select the second DSR format.

In some embodiments, the UE may report two DSR MAC CEs for different subsets LCG/LCHs, one based on a first DSR MAC CE format, and one based on a second DSR MAC CE format.

The two DSR MAC CEs may be transmitted using the same or different MAC PDUs. In some embodiments, the UE may select DSR MAC CE based on the uplink grant size. If the uplink grant size is larger than a threshold, a first DSR MAC CE format may be used for reporting. Otherwise, a second DSR MAC CE format may be used for reporting.

In some embodiments, the UE may report DSR MAC CE using the padding bits (if available after multiplexing of data) in an uplink shared channel (UL-SCH) resource. If the number of padding bits is sufficient for a first DSR MAC CE format, a first DSR MAC CE format may be used for reporting. Otherwise, a second DSR MAC CE format may be used for reporting.

In some embodiments, the UE may select a DSR MAC CE format based on whether the buffered delay-critical data includes an important (or less-important) packet (e.g., a PDU Set with PDU Set importance higher/lower than a threshold). If the buffered delay-critical data includes an important packet, the UE may select a first DSR MAC CE format to report DSR. Otherwise, a second DSR MAC CE format may be used for reporting.

In some embodiments, the UE may select DSR MAC CE format based on the quality of service (QOS) requirement (e.g., target reliability and/or packet delay budget) of data flows corresponding to the LCHs that triggered the DSR.

In some embodiments, the UE may select DSR MAC CE based on the channel quality of the serving cell where the MAC PDU (which may include the DSR MAC CE) is to be transmitted. For example, if the signal to interference plus noise ratio (SINR)/reference signal received power (RSRP)/reference signal received quality (RSRQ) is higher than a threshold, a first DSR MAC CE format may be used for reporting. Otherwise, if the SINR/RSRP/RSRQ is lower than a threshold, a second DSR MAC CE format may be used for reporting.

In some embodiments, the DSR MAC CE format may be flexible in terms of the fields to be included in the MAC CE (so the size of such MAC CE is variable). In such cases, some indicators/fields may be included in the MAC CE to indicate whether this MAC CE would also include additional fields. This may be realized by including one or more bits/fields in the MAC CE to indicate the “presence,” “extension,” and/or “type” of the information to be reported in this DSR.

In some embodiments, different DSR MAC CE formats may have different priority order, for logical channel prioritization (LCP) procedures. For example, a first DSR MAC CE format may have a higher priority than a second DSR MAC CE format.

In some embodiments, the UE may select DSR MAC CE format based on the uplink grant type for the MAC PDU for DSR MAC CE transmission. For example, the UE may select the DSR MAC CE format based on whether the grant is a dynamic grant or configured grant. For example, the UE may only be allowed to report a first DSR MAC CE format on configured grants, but not on dynamic grants. Accordingly, the UE may report a second DSR MAC CE format on dynamic grants in this example.

As another example, the UE may select the DSR MAC CE format based on a specific configured grant configuration. For example, the UE may only be allowed to report a first DSR MAC CE format on resources of specific configured grant configurations. Accordingly, the UE may report a second DSR MAC CE format on other resources than the specific configured grant configurations.

As another example, the UE may select the DSR MAC CE format based on a dynamic grant with specific layer 1 (L1)-priority. For example, the UE may only be allowed to report a first DSR MAC CE format on dynamic grants with higher L1-priority. Accordingly, the UE may report a second DSR MAC CE format on dynamic grants without higher L1-priority and/or non-dynamic grants.

In some embodiments, the base station may send a dynamic signaling (e.g., a MAC CE, or a downlink control information (DCI)) to explicitly/implicitly instruct the UE to switch the DSR MAC CE format. The base station may pre-configure a default DSR MAC CE format via radio resource control (RRC), and switch the format using dynamic signaling. In some embodiments, the UE may autonomously fallback to the default DSR MAC CE sometimes after reception of such dynamic signaling.

In some embodiments, the UE may report DSR using a first DSR MAC CE format or type periodically, while report DSR using a second DSR MAC CE format or type based on an aperiodic triggering event. In one example, the UE may be configured to report Rel-18 DSR MAC CE based on a pre-configured periodicity, and only report Rel-19 DSR MAC CE when a condition is satisfied.

In a first option of a second approach (which may be referred to as “Approach 2a”), a DSR MAC CE format may include indication of “Detail Level” per LCG in a single MAC CE.

An assumption for the first option of the second approach may be that multiple LCGs have triggered DSR, and the UE can send one MAC CE to report DSR for all these LCGs. For some of these LCGs, “simplified” delay information may be sufficient. For example, all the buffered PDCP SDUs in a LCG may have the same remaining time, so only one pair of remaining time value and buffer size information may be needed for this LCG (this may correspond to a first detail level). For some of these LCGs, “more detailed” delay information may be needed. For example, the buffered PDCP SDUs in a LCG may have very different remaining times, so multiple pairs of remaining time values and buffer size information may be needed for DSR of this LCG (this may correspond to a second detail level). A question to be addressed for the first option of the second approach may be how to include the DSR for these LCGs with different requirements of “detail levels” in the same DSR MAC CE.

For the first option of the second approach, a new bitmap can be included in the DSR MAC CE to indicate the “level of details” for the DSR of each LCG to be reported. It can be assumed that only two levels of details are implemented in some embodiments, so 1 bit is enough for one LCG. However, this does not preclude the cases with more than two levels of details and/or more than 1 bit is utilized.

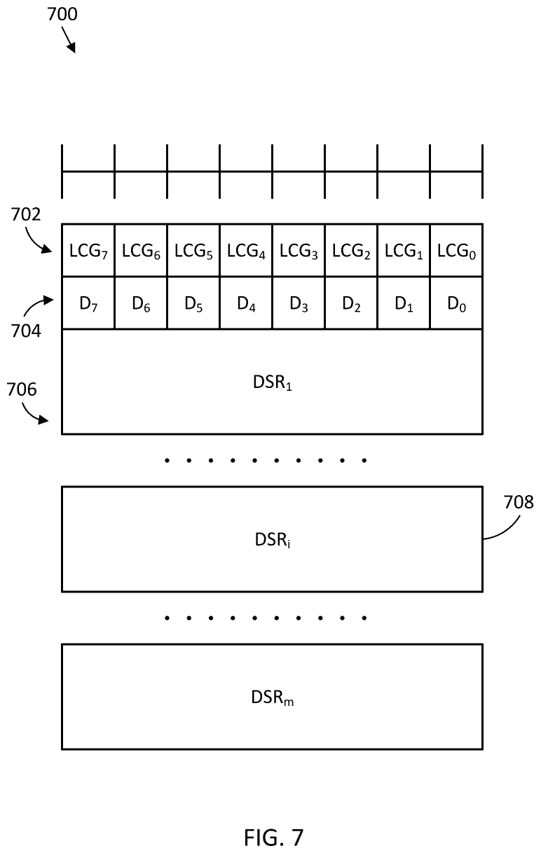

FIG. 7 illustrates an example DSR MAC CE structure 700 in accordance with some embodiments. The structure 700 may implement the bitmap included in the DSR MAC CE of the first option of the second approach. The structure 700 may have a Rel-19 DSR MAC CE format and/or may include one or more features of a Rel-19 DSR MAC CE format.

The structure 700 may include one or more LCG indication fields 702. The LCG indication fields 702 may form a bitmap. A bitmap may indicate which LCGs are concerned in this DSR MAC CE (this field is same as the legacy). The LCG indication fields 702 may include one or more of the features of the LCG indication fields 502 (FIG. 5). For example, the LCG indication fields 702 may indicate the presence of delay information for the LCGs. An LCG indication field of the LCG indication fields 702 set to 1 may indicate that the delay information for the LCG is reported. An LCG field set to 0 may indicate that the delay information for the LCG is not reported.

The structure 700 may include a bitmap 704 that includes one or more detail level fields. The bitmap 704 may include a detail level field corresponding to each of the LCG. For example, the bitmap 704 may include detail level fields that correspond one to one with the LCG indication fields 702. The detail level fields may indicate the level of details provided in DSR sections of the corresponding LCG. For example, the bitmap 704 may indicate the “level of details” of DSR for each LCG to be reported. A detail level field value of 1 may indicate more details (e.g., more than one pair of remaining time value and buffer size). A detail level field value of 0 may indicate less details (e.g., only one pair of remaining time value and buffer size). DSR with different levels of details may require different number of bytes.

The structure 700 may include one or more DSRs 706 for one or more LCGs. The structure 700 may include a DSR for each of the LCGs for which the LCG indication fields 702 indicate having the presence of delay information. The size (in terms of number of bytes) of the DSRs may differ based on the level of details corresponding to the DSRs, as indicated by the bitmap 704. As an example, the DSRs 706 may include a DSR 708 for an i-th LCG in the illustrated embodiment. As an example, the DSR 708 for the i-th LCG may have M or N bytes depends on whether it is a “more detailed” or “less detailed” DSR, where M may not be equal to N. Each DSR may include one or more remaining times, and/or one or more buffer sizes. The buffer size could correspond to either delay-critical data volume or all data volume of the buffer of the LCG.

As another embodiment of the first option of the second approach, the indication of “Detail Level” may be per LCG in single MAC CE.

A DSR MAC CE with DSR for multiple LCGs may have an indicator included in a DSR for each LCG, which indicates whether the DSR is based on more detailed or the basic format. Different DSRs for different LCGs in one MAC CE may take different number of bytes/bits, depending on their “level of details.” The “location” of this indicator can be anywhere within the DSR.

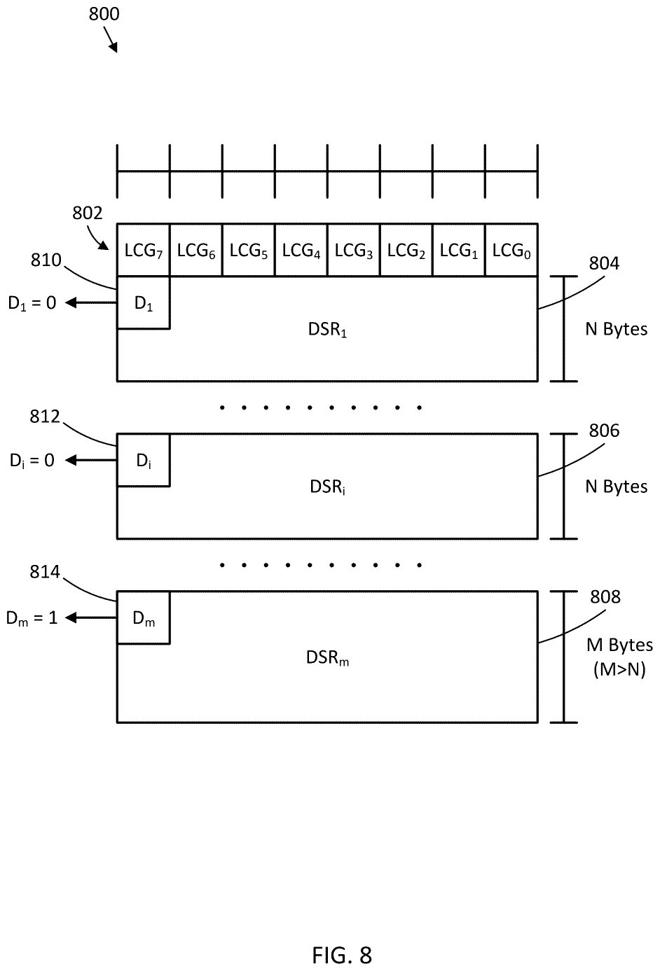

FIG. 8 illustrates another example DSR MAC CE structure 800 in accordance with some embodiments. The structure 800 may implement the detail level per LCGs in the DSR. The structure 800 may have a Rel-19 DSR MAC CE format and/or may include one or more features of a Rel-19 DSR MAC CE format.

The structure 800 may include one or more LCG indication fields 802. The LCG indication fields 802 may form a bitmap. A bitmap may indicate which LCGs are concerned in this DSR MAC CE (this field is same as the legacy). The LCG indication fields 802 may include one or more of the features of the LCG indication fields 502 (FIG. 5). For example, the LCG indication fields 802 may indicate the presence of delay information for the LCGs. An LCG indication field of the LCG indication fields 802 set to 1 may indicate that the delay information for the LCG is reported. An LCG field set to 0 may indicate that the delay information for the LCG is not reported.

The structure 800 may include one or more DSRs. The structure 800 may include a DSR for each of the LCGs for which the LCG indication fields 802 indicate having the presence of delay information. A first DSR 804, a second DSR 806, and a third DSR 808 are illustrated in the illustrated embodiment. Each of the first DSR 804, the second DSR 806, and the third DSR 808 may correspond to different LCGs.

Each of the DSRs may include a detail level field that indicates a level of detail of the corresponding DSR. For example, the first DSR 804 includes a first detail level field 810, the second DSR 806 includes a second detail level field 812, and the third DSR 808 includes a third detail level field 814 in the illustrated embodiment. The size (in terms of number of bytes) of the DSRs may differ based on the level of details corresponding to the DSRs, as indicated by the DSRs. As an example, the first detail level field 810 and the second detail level field 812 indicate that the first DSR 804 and the second DSR 806 are less detailed DSRs in the illustrated embodiment. The first DSR 804 and the second DSR 806 each may have N bytes based on being less detailed. The third detail level field 814 indicates that the third DSR 808 is a more detailed DSR in the illustrated embodiment. The third DSR 808 may have M bytes based on being more detailed, where the value of M is greater than the value of N. Each DSR may include one or more remaining times, and/or one or more buffer sizes (e.g., buffer sizes correspond to different remaining time thresholds).

In a second option of the second approach (which may be referred to as “Approach 2b”), a DSR MAC CE format may include “BS Table Selection” for different data portions.

An assumption for the second option of the second approach may be that, in the DSR MAC CE, the UE needs to report multiple Buffer Size (BS) values for different portions of data buffered in one LCG, such as the buffer sizes corresponding to different remaining time thresholds. For example, the BS corresponding to the PDCP SDUs with remaining time in a specific range may be reported as data volume with remaining time less than 5 ms is 800 K, data volume with remaining time between 5 ms and 10 ms is 200 K, and data volume with remaining time between 10 ms and 20 ms is 500 K. Depending on the data volume in each portion, different BS table may be selected for reporting. If the data volume falls into the range of Table 6.1.3.1-3 in TS 38.321, Table 6.1.3.1-3 may be used. Otherwise, Table 6.1.3.1-2 may be used.

For the second option of the second approach, a bitmap can be included in the DSR MAC CE to indicate the “BS table selection” for multiple BS values to be reported for DSR of one LCG to be reported. The first bit may represent the BS table for the first data portion in this LCG, the second bit may represent the BS table for the second data portion in this LCG, and so on. When the DSR MAC CE aims to indicate DSR for multiple LCGs, multiple bitmaps can be included (one bitmap for each LCG).

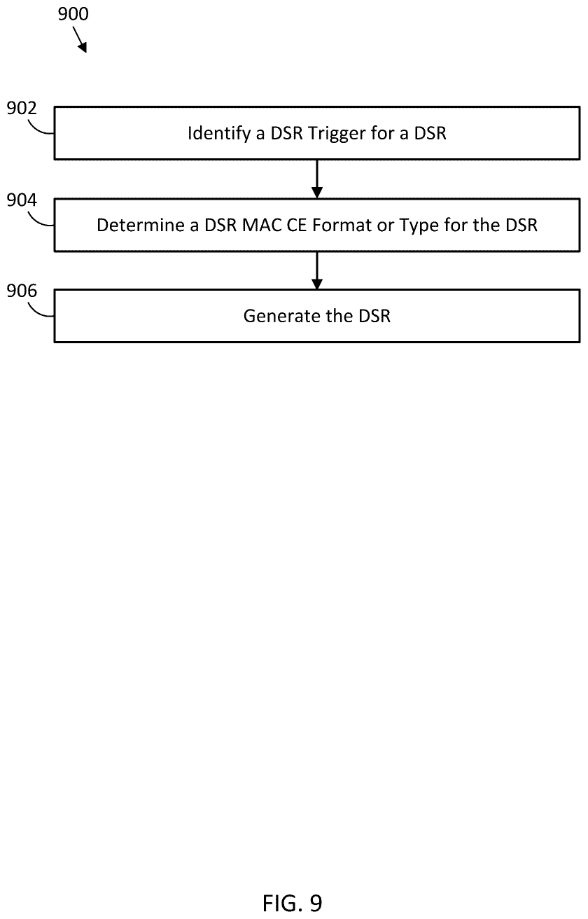

FIG. 9 illustrates an example procedure 900 for generating a DSR in accordance with some embodiments. The DSR may be generated in accordance with a determined DSR MAC CE format. The procedure 900 may be performed by a UE, such as the UE 104 (FIG. 1), UE 106 (FIG. 1), and/or the UE 200 (FIG. 2).

The procedure 900 may include identifying a DSR trigger for a DSR in 902.

The procedure 900 may include determining a DSR MAC CE format or type for the DSR in 904. For example, the UE may determine a DSR MAC CE format or type for the DSR based at least in part on one or more characteristics related to the DSR.

In some embodiments, determining the DSR MAC CE format or type may include determining whether a condition is satisfied for the DSR, wherein the DSR MAC CE format is determined based at least in part on whether the condition is determined to be satisfied. The condition may relate to which logical channel (LCH) or logical channel group (LCG) triggered the DSR, one or more buffered data volumes of one or more LCHs or one or more LCGs that triggered the DSR, one or more remaining time values of buffered data of one or more LCHs or one or more LCGs that triggered the DSR, one or more configurations of delay status reporting of one or more LCHs or one or more LCGs that triggered the DSR, a number of one or more LCHs or one or more LCGs that triggered the DSR, one or more importance levels of buffered data of one or more LCHs or one or more LCGs that triggered the DSR, a number of padding bits in a radio resource to be utilized for transmission of the DSR, a size of a radio resource to be utilized for transmission of the DSR, or a type of a radio resource to be utilized for transmission of the DSR in some embodiments.

In some embodiments, determining the DSR MAC CE format or type may include determining whether a number of logical channel groups (LCGs) or logical channels (LCHs) that triggered the DSR exceeds a threshold number of LCGs or LCHs, determining whether an LCG or an LCH that triggered the DSR is configured for a certain MAC CE format, determining whether an LCG or an LCH that triggered the DSR has a priority higher than a threshold priority, or determining whether an LCG or an LCH that triggered the DSR has a delay-critical data volume or a non-delay-critical volume larger than a threshold value.

In some embodiments, determining the DSR MAC CE format or type may include determining whether a buffer size associated with a remaining time range or a remaining time threshold of the DSR exceeds a threshold data volume, or determining whether a number of remaining time ranges of the DSR associated with data volumes exceeding a threshold data volume exceed a threshold number.

In some embodiments, determining the DSR MAC CE format or type may includes determining a difference between two remaining time values for the DSR, and determining whether the difference exceeds a threshold difference.

In some embodiments, determining the DSR MAC CE format or type may include determining the DSR MAC CE format based at least in part on whether an uplink grant size for the DSR is larger than an uplink grant size threshold, determining the DSR MAC CE format based at least in part on a number of padding bits in an uplink shared channel (UL-SCH) resource for the DSR, determining the DSR MAC CE format based at least in part on whether a buffered delay-critical data of the DSR includes an important packet, or determining the DSR MAC CE format based at least in part on a quality of service (QOS) requirement of data flows corresponding to one or more logical channels (LCHs) that triggered the DSR.

In some embodiments, determining the DSR MAC CE format or type may include determining the DSR MAC CE format based at least in part on a channel quality of a serving cell where a MAC packet data unit (PDU) that includes the DSR is to be transmitted, or determining the DSR MAC CE format based at least in part on an uplink grant type for a MAC PDU for transmission of the DSR.

In some embodiments, the DSR MAC CE format or type may include one or more bits or fields that indicate information to be reported in the DSR. Further, the procedure 900 may include identifying an indication of the DSR MAC CE format received from a base station in some embodiments, wherein the DSR MAC CE format is determined based at least in part on the indication.

The procedure 900 may include generating the DSR in 906. For example, the UE may generate the DSR in accordance with the DSR MAC CE format for transmission.

In some embodiments, the DSR MAC CE format may be a first DSR MAC CE format, wherein the first DSR MAC CE format is determined for a first subset of LCGs or LCHs for the DSR. Further, generating the DSR may include generating a first portion of the DSR corresponding to the first subset in accordance with the first DSR MAC CE format. The method may further comprises determining a second DSR MAC CE format for a second subset of LCGs or LCHs for the DSR, wherein generating the DSR includes generating a second portion of the DSR corresponding to the second subset in accordance with the second DSR MAC CE format.

Any one or more of the operations in FIG. 9 may be performed in a different order than shown and/or one or more of the operations may be performed concurrently in embodiments. Further, it should be understood that one or more of the operations may be omitted from and/or one or more additional operations may be added to the procedure 900 in other embodiments.

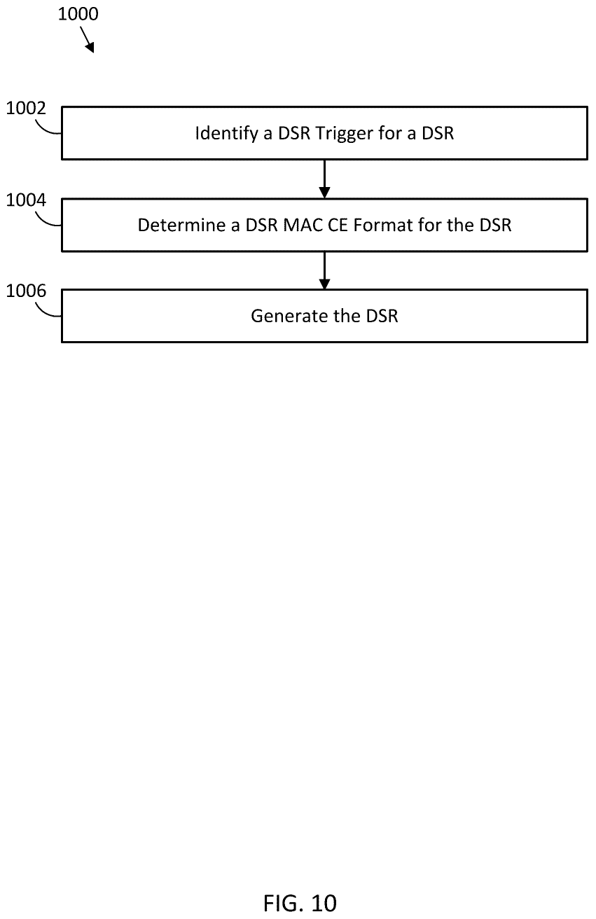

FIG. 10 illustrates an example procedure 1000 for generating a DSR in accordance with some embodiments. The DSR may be generated in accordance with a determined DSR MAC CE format. The procedure 1000 may be performed by a UE, such as the UE 104 (FIG. 1), UE 106 (FIG. 1), and/or the UE 200 (FIG. 2).

The procedure 1000 may include identifying a DSR trigger for a DSR in 1002.

The procedure 1000 may include determining a DSR MAC CE format for the DSR in 1004. The DSR MAC CE format may include one or more level of detail indicators for indicating a level of detail for each logical channel group (LCG) to be reported in the DSR, or one or more buffer size (BS) table selection indicators for indicating one or more BS tables for one or more data portions of one or more LCGs for the DSR. In some embodiments, determine the DSR MAC CE format may include determining a field indicating a DSR format for an LCG in a DSR MAC CE.

In some embodiments, the DSR MAC CE format may include the one or more level of detail indicators, and wherein the one or more level of detail indicators includes a bitmap that indicates the level of detail for each to be reported in the DSR. Further, the DSR MAC CE format may include the one or more BS table selection indicators in some embodiments, wherein the DSR is to include information for multiple LCGs, and wherein the one or more BS table selection indicators include multiple bitmaps for the multiple LCGs.

In some embodiments, the DSR MAC CE format may include the one or more BS table selection indicators, and wherein the one or more BS table selection indicators include a bitmap that indicates BS table selection for one or more BS values to be reported for an LCG of the one or more LCGs. In some of these embodiments, the bitmap includes a first bit for a first data portion of the LCG and a second bit for a second data portion of the LCG.

The procedure 1000 may generate the DSR in 1006. For example, the UE may generate the DSR in accordance with the DSR MAC CE format for transmission.

Any one or more of the operations in FIG. 10 may be performed in a different order than shown and/or one or more of the operations may be performed concurrently in embodiments. Further, it should be understood that one or more of the operations may be omitted from and/or one or more additional operations may be added to the procedure 1000 in other embodiments.

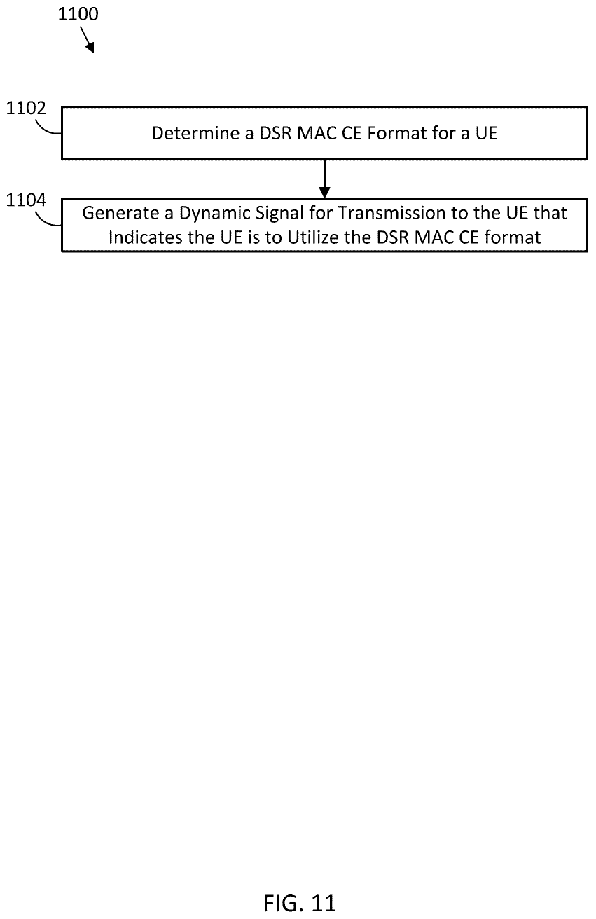

FIG. 11 illustrates an example procedure 1100 for indicating a DSR MAC CE format to be utilized in accordance with some embodiments. The procedure 1100 may be performed by a base station, such as the base station 108 (FIG. 1) and/or the network device 300 (FIG. 3).

The procedure 1100 may include determining a DSR MAC CE format for a UE in 1102.

In some embodiments, the DSR MAC CE format may be a first DSR MAC CE format, wherein the procedure 1100 may further comprise configuring the UE with a second DSR MAC CE format, and wherein the dynamic signal may reconfigure the UE from the second DSR MAC CE format to the first DSR MAC CE format. In some embodiments, the UE may be configured with the second DSR MAC CE format via an RRC signaling.

The procedure 1100 may include generating a dynamic signal for transmission to the UE that indicates the UE is to utilize the DSR MAC CE format in 1104. In some embodiments, the dynamic signal may include a MAC CE signal or a downlink control information (DCI) signal.

Any one or more of the operations in FIG. 11 may be performed in a different order than shown and/or one or more of the operations may be performed concurrently in embodiments. Further, it should be understood that one or more of the operations may be omitted from and/or one or more additional operations may be added to the procedure 1100 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying a delay status report (DSR) trigger for a DSR, determining a DSR medium access control (MAC) control element (CE) format or type for the DSR based at least in part on one or more characteristics related to the DSR, and generating the DSR in accordance with the DSR MAC CE format for transmission.

Example 2 may include the method of example 1, wherein determining the DSR MAC CE format or type includes determining whether a condition is satisfied for the DSR, wherein the DSR MAC CE format is determined based at least in part on whether the condition is determined to be satisfied.

Example 3 may include the method of example 2, wherein the condition relates to which logical channel (LCH) or logical channel group (LCG) triggered the DSR, one or more buffered data volumes of one or more LCHs or one or more LCGs that triggered the DSR, one or more remaining time values of buffered data of one or more LCHs or one or more LCGs that triggered the DSR, one or more configurations of delay status reporting of one or more LCHs or one or more LCGs that triggered the DSR, a number of one or more LCHs or one or more LCGs that triggered the DSR, one or more importance levels of buffered data of one or more LCHs or one or more LCGs that triggered the DSR, a number of padding bits in a radio resource to be utilized for transmission of the DSR, a size of a radio resource to be utilized for transmission of the DSR, or a type of a radio resource to be utilized for transmission of the DSR.

Example 4 may include the method of example 1, wherein determining the DSR MAC CE format or type includes determining whether a number of logical channel groups (LCGs) or logical channels (LCHs) that triggered the DSR exceeds a threshold number of LCGs or LCHs, determining whether an LCG or an LCH that triggered the DSR is configured for a certain MAC CE format, determining whether an LCG or an LCH that triggered the DSR has a priority higher than a threshold priority, or determining whether an LCG or an LCH that triggered the DSR has a delay-critical data volume or a non-delay-critical volume larger than a threshold value.

Example 5 may include the method of example 1, wherein determining the DSR MAC CE format or type includes determining whether a buffer size associated with a remaining time range or a remaining time threshold of the DSR exceeds a threshold data volume, or determining whether a number of remaining time ranges of the DSR associated with data volumes exceeding a threshold data volume exceed a threshold number.

Example 6 may include the method of example 1, wherein determining the DSR MAC CE format includes determining a difference between two remaining time values for the DSR, and determining whether the difference exceeds a threshold difference.

Example 7 may include the method of example 1, wherein the DSR MAC CE format is a first DSR MAC CE format, wherein the first DSR MAC CE format is determined for a first subset of LCGs or LCHs for the DSR, wherein generating the DSR includes generating a first portion of the DSR corresponding to the first subset in accordance with the first DSR MAC CE format, and wherein the method further comprises determining a second DSR MAC CE format for a second subset of LCGs or LCHs for the DSR, wherein generating the DSR includes generating a second portion of the DSR corresponding to the second subset in accordance with the second DSR MAC CE format.

Example 8 may include the method of example 1, wherein determining the DSR MAC CE format or type includes determining the DSR MAC CE format based at least in part on whether an uplink grant size for the DSR is larger than an uplink grant size threshold, determining the DSR MAC CE format based at least in part on a number of padding bits in an uplink shared channel (UL-SCH) resource for the DSR, determining the DSR MAC CE format based at least in part on whether a buffered delay-critical data of the DSR includes an important packet, or determining the DSR MAC CE format based at least in part on a quality of service (QoS) requirement of data flows corresponding to one or more logical channels (LCHs) that triggered the DSR.

Example 9 may include the method of example 1, wherein determining the DSR MAC CE format or type includes determining the DSR MAC CE format based at least in part on a channel quality of a serving cell where a MAC packet data unit (PDU) that includes the DSR is to be transmitted, or determining the DSR MAC CE format based at least in part on an uplink grant type for a MAC PDU for transmission of the DSR.

Example 10 may include the method of example 1, wherein the DSR MAC CE format includes one or more bits or fields that indicate information to be reported in the DSR.

Example 11 may include the method of example 1, further comprising identifying an indication of the DSR MAC CE format received from a base station, wherein the DSR MAC CE format is determined based at least in part on the indication.

Example 12 may include the method of example 1, wherein the DSR MAC CE format or type includes one or more remaining time/buffer size pairs per logical channel group (LCG).

Example 13 may include a method comprising identifying a delay status report (DSR) trigger for a DSR, determining a DSR medium access control (MAC) control element (CE) format for the DSR, the DSR MAC CE format including one or more level of detail indicators for indicating a level of detail for each logical channel group (LCG) to be reported in the DSR, or one or more buffer size (BS) table selection indicators for indicating one or more BS tables for one or more data portions of one or more LCGs for the DSR, and generating the DSR in accordance with the DSR MAC CE format for transmission.

Example 14 may include the method of example 13, wherein the DSR MAC CE format includes the one or more level of detail indicators, and wherein the one or more level of detail indicators includes a bitmap that indicates the level of detail for each to be reported in the DSR.

Example 15 may include the method of example 13, wherein the DSR MAC CE format includes the one or more BS table selection indicators, and wherein the one or more BS table selection indicators include a bitmap that indicates BS table selection for one or more BS values to be reported for an LCG of the one or more LCGs.

Example 16 may include the method of example 15, wherein the bitmap includes a first bit for a first data portion of the LCG and a second bit for a second data portion of the LCG.

Example 17 may include the method of example 13, wherein the DSR MAC CE format includes the one or more BS table selection indicators, wherein the DSR is to include information for multiple LCGs, and wherein the one or more BS table selection indicators include multiple bitmaps for the multiple LCGs.

Example 18 may include a method comprising determining a delay status report (DSR) medium access control (MAC) control element (CE) format for a user equipment (UE), and generating a dynamic signal for transmission to the UE that indicates the UE is to utilize the DSR MAC CE format.

Example 19 may include the method of example 18, wherein the dynamic signal includes a MAC CE signal or a downlink control information (DCI) signal.

Example 20 may include the method of example 18, wherein the DSR MAC CE format is a first DSR MAC CE format, wherein the method further comprises configuring the UE with a second DSR MAC CE format, and wherein the dynamic signal reconfigures the UE from the second DSR MAC CE format to the first DSR MAC CE format.

Example 21 may include the method of example 20, wherein the UE is configured with the second DSR MAC CE format via a radio resource control (RRC) signaling.

Example 22 may include an apparatus comprising means to perform one or more elements of a method described in or related to any of examples 1-21, or any other method or process described herein.

Example 23 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 24 may include an apparatus comprising logic, modules, or circuitry to perform one or more elements of a method described in or related to any of examples 1-21, or any other method or process described herein.

Example 25 may include a method, technique, or process as described in or related to any of examples 1-21, or portions or parts thereof.

Example 26 may include an apparatus comprising: one or more processors and one or more computer-readable media comprising instructions that, when executed by the one or more processors, cause the one or more processors to perform the method, techniques, or process as described in or related to any of examples 1-21, or portions thereof.

Example 27 may include a signal as described in or related to any of examples 1-21, or portions or parts thereof.

Example 28 may include a datagram, information element, packet, frame, segment, PDU, or message as described in or related to any of examples 1-21, or portions or parts thereof, or otherwise described in the present disclosure.

Example 29 may include a signal encoded with data as described in or related to any of examples 1-21, or portions or parts thereof, or otherwise described in the present disclosure.

Example 30 may include a signal encoded with a datagram, IE, packet, frame, segment, PDU, or message as described in or related to any of examples 1-21, or portions or parts thereof, or otherwise described in the present disclosure.

Example 31 may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Example 32 may include a computer program comprising instructions, wherein execution of the program by a processing element is to cause the processing element to carry out the method, techniques, or process as described in or related to any of examples 1-21, or portions thereof.

Example 33 may include a signal in a wireless network as shown and described herein.

Example 34 may include a method of communicating in a wireless network as shown and described herein.

Example 35 may include a system for providing wireless communication as shown and described herein.

Example 36 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
identify a delay status report (DSR) trigger for a DSR;
determine a DSR medium access control (MAC) control element (CE) format or type for the DSR based at least in part on one or more characteristics related to the DSR; and
generate the DSR in accordance with the DSR MAC CE format for transmission.

2. The one or more non-transitory, computer-readable media of claim 1, wherein to determine the DSR MAC CE format or type includes to:
determine whether a condition is satisfied for the DSR, wherein the DSR MAC CE format is determined based at least in part on whether the condition is determined to be satisfied.

3. The one or more non-transitory, computer-readable media of claim 2, wherein the condition relates to:
which logical channel (LCH) or logical channel group (LCG) triggered the DSR;
one or more buffered data volumes of one or more LCHs or one or more LCGs that triggered the DSR;
one or more remaining time values of buffered data of one or more LCHs or one or more LCGs that triggered the DSR;
one or more configurations of delay status reporting of one or more LCHs or one or more LCGs that triggered the DSR;
a number of one or more LCHs or one or more LCGs that triggered the DSR;
one or more importance levels of buffered data of one or more LCHs or one or more LCGs that triggered the DSR;
a number of padding bits in a radio resource to be utilized for transmission of the DSR;
a size of a radio resource to be utilized for transmission of the DSR; or
a type of a radio resource to be utilized for transmission of the DSR.

4. The one or more non-transitory, computer-readable media of claim 1, wherein to determine the DSR MAC CE format or type includes to:
determine whether a number of logical channel groups (LCGs) or logical channels (LCHs) that triggered the DSR exceeds a threshold number of LCGs or LCHs;
determine whether an LCG or an LCH that triggered the DSR is configured for a certain MAC CE format;
determine whether an LCG or an LCH that triggered the DSR has a priority higher than a threshold priority; or
determine whether an LCG or an LCH that triggered the DSR has a delay-critical data volume or a non-delay-critical volume larger than a threshold value.

5. The one or more non-transitory, computer-readable media of claim 1, wherein to determine the DSR MAC CE format or type includes to:
determine whether a buffer size associated with a remaining time range or a remaining time threshold of the DSR exceeds a threshold data volume; or
determine whether a number of remaining time ranges of the DSR associated with data volumes exceeding a threshold data volume exceed a threshold number.

6. The one or more non-transitory, computer-readable media of claim 1, wherein to determine the DSR MAC CE format includes to:
determine a difference between two remaining time values for the DSR; and
determine whether the difference exceeds a threshold difference.

7. The one or more non-transitory, computer-readable media of claim 1, wherein the DSR MAC CE format is a first DSR MAC CE format, wherein the first DSR MAC CE format is determined for a first subset of LCGs or LCHs for the DSR, wherein to generate the DSR includes to generate a first portion of the DSR corresponding to the first subset in accordance with the first DSR MAC CE format, and wherein the instructions, when executed, further cause the processing circuitry to:
determine a second DSR MAC CE format for a second subset of LCGs or LCHs for the DSR, wherein to generate the DSR includes to generate a second portion of the DSR corresponding to the second subset in accordance with the second DSR MAC CE format.

8. The one or more non-transitory, computer-readable media of claim 1, wherein to determine the DSR MAC CE format or type includes to:
determine the DSR MAC CE format based at least in part on whether an uplink grant size for the DSR is larger than an uplink grant size threshold;
determine the DSR MAC CE format based at least in part on a number of padding bits in an uplink shared channel (UL-SCH) resource for the DSR;
determine the DSR MAC CE format based at least in part on whether a buffered delay-critical data of the DSR includes an important packet; or
determine the DSR MAC CE format based at least in part on a quality of service (QOS) requirement of data flows corresponding to one or more logical channels (LCHs) that triggered the DSR.

9. The one or more non-transitory, computer-readable media of claim 1, wherein to determine the DSR MAC CE format or type includes to:
determine the DSR MAC CE format based at least in part on a channel quality of a serving cell where a MAC packet data unit (PDU) that includes the DSR is to be transmitted; or
determine the DSR MAC CE format based at least in part on an uplink grant type for a MAC PDU for transmission of the DSR.

10. The one or more non-transitory, computer-readable media of claim 1, wherein the DSR MAC CE format includes one or more bits or fields that indicate information to be reported in the DSR.

11. The one or more non-transitory, computer-readable media of claim 1, wherein the instructions, when executed, further cause the processing circuitry to:
identify an indication of the DSR MAC CE format received from a base station, wherein the DSR MAC CE format is determined based at least in part on the indication.

12. The one or more non-transitory, computer-readable media of claim 1, wherein the DSR MAC CE format or type includes one or more remaining time/buffer size pairs per logical channel group (LCG).

13. An apparatus comprising:
processing circuitry to:
identifying a delay status report (DSR) trigger for a DSR;
determining a DSR medium access control (MAC) control element (CE) format for the DSR, the DSR MAC CE format including:
one or more level of detail indicators for indicating a level of detail for each logical channel group (LCG) to be reported in the DSR; or
one or more buffer size (BS) table selection indicators for indicating one or more BS tables for one or more data portions of one or more LCGs for the DSR; and
generating the DSR in accordance with the DSR MAC CE format for transmission; and
interface circuitry coupled with the processing circuitry, the interface circuitry to communicatively couple the processing circuitry with a component of a device.

14. The apparatus of claim 13, wherein the DSR MAC CE format includes the one or more level of detail indicators, and wherein the one or more level of detail indicators includes a bitmap that indicates the level of detail for each to be reported in the DSR.

15. The apparatus of claim 13, wherein the DSR MAC CE format includes the one or more BS table selection indicators, and wherein the one or more BS table selection indicators include a bitmap that indicates BS table selection for one or more BS values to be reported for an LCG of the one or more LCGs.

16. The apparatus of claim 15, wherein the bitmap includes a first bit for a first data portion of the LCG and a second bit for a second data portion of the LCG.

17. The apparatus of claim 13, wherein the DSR MAC CE format includes the one or more BS table selection indicators, wherein the DSR is to include information for multiple LCGs, and wherein the one or more BS table selection indicators include multiple bitmaps for the multiple LCGs.

18. A method comprising:
determining a delay status report (DSR) medium access control (MAC) control element (CE) format for a user equipment (UE); and
generating a dynamic signal for transmission to the UE that indicates the UE is to utilize the DSR MAC CE format.

19. The method of claim 18, wherein the dynamic signal includes a MAC CE signal or a downlink control information (DCI) signal.

20. The method of claim 18, wherein the DSR MAC CE format is a first DSR MAC CE format, wherein the method further comprises configuring the UE with a second DSR MAC CE format, and wherein the dynamic signal reconfigures the UE from the second DSR MAC CE format to the first DSR MAC CE format.
